(19) United States
(12) Patent Application Publication
(10) Pub. No.: US 2008/0219485 A1
(43) Pub. Date: Sep. 11, 2008

(54) Apparatus, System and Method for Acoustic Signals

(75) Inventor: Martin Kantola, Karpero (FI)

Correspondence Address: SUGHRUE MION, PLLC, 2100 PENNSYLVANIA AVENUE, N.W., SUITE 800, WASHINGTON, DC, 20037, US

(73) Assignee: OY MARTIN KANTOLA CONSULTING LTD., Karpero (FI)

(21) Appl. No.: 11/915,675

(22) PCT Filed: May 26, 2006
(86) PCT No.: PCT/FI06/50216

§ 371 Date: Dec. 19, 2007

(30) Foreign Application Priority Data
May 27, 2005 (FI) 20055260

(51) Int. Cl. H04R 5/02

(52) U.S. Cl. 381/303

(57) ABSTRACT

The invention relates to an apparatus, system, and method for receiving or reproducing sound. In the method, acoustic signals are received with two dual-diaphragm acoustic transducers (10, 20) having a figure-of-eight directional pattern, which are directed on two-dimensional plane perpendicular to each other, and the directional patterns have directional pattern halves (XA, XB) and (YA, YB), respectively; a first signal (X) and a second signal (Y) are generated from the received signals. The method is characterised in that an omnidirectional signal (Wn) is also generated, wherein (Wₙ) is calculated by summing the directional pattern halves (XA, XB) and (YA, YB) of two signals in such a manner that the two acoustic transducers (10, 20) having a figure-of-eight directional pattern provide not only the first (X) and second (Y) signals, but also the omni-directional signal (Wₙ) having an omni-directional pattern, whereby the combination of these three generated signals (X, Y, Wₙ) provides a directed directional pattern pointing to a desired direction on two-dimensional plane. The invention also provides an apparatus and system for implementing the method.

### BACKGROUND OF THE INVENTION

The invention relates to the technique of recording and reproducing spatial sound. As home theatres are becoming more common, a large portion of consumers has a home theatre. The aim of home theatres is to reproduce credible spatial sound, such as in a recording situation. At present, the equipment is most generally of type 5.1, including two front loudspeakers, a central loudspeaker, two back loudspeakers and one subwoofer controlled by the LFE channel for low-frequency sound effects. Other such Surround systems include the 7.1, 8.1 and 10.2 systems, for example, part of which are designed only for theatre use, not for an ordinary consumer. However, such 5.1 equipment requires six channels and does not include elevation information. In such systems, the loudspeakers are to be placed at the designed locations around the listener.

However, it is practically impossible to reproduce sound according to the original recording situation, and consequently, techniques have to be employed for producing a sound world that sounds as authentic as possible. For example, in reproduction with earphones, attempts have been made to model the behaviour of the ear with HRTF (Head Related Transfer Function). However, a signal modified with HRTF has conventionally been an artificially panned mono source.

In the 1970's, a technique called Ambisonics, which was designed as a recording technique for spatial sound, was developed for recording and reproducing spatial sound. However, in recording sound, the Ambisonics technique is expensive. In recording, a Soundfield microphone has to be employed that tends to receive the entire 360° sound field by means of four adjacent cardioid capsules placed in the form of a tetrahedron. Patent publication EP 0869967 B1 discloses a microphone intended for recording spatial sound. Therein, the microphones have an omni-directional pattern. In this case, the microphones have to be placed on the surface of a hard ball. Between the several microphones placed on the surface of the ball is a distance of the length of the diameter of the ball. This distance causes harmful time differences.

### BRIEF DESCRIPTION OF THE INVENTION

It is thus an object of the invention to provide a system and method for receiving and reproducing acoustic signals. A system and method of acoustic transducers intended for receiving and reproducing 2D and 3D spatial sound is implemented in such a manner that in spite of its simple structure, the system is capable of providing good-quality reception or reproduction of spatial sound. The object of the invention is achieved with a system and method characterized by what is stated in the independent claims. Preferred embodiments of the invention are disclosed in the dependent claims.

One aspect of the invention is to provide a system and method of acoustic transducers, in which signals from different directions can be received on XY plane with two or three dual-diaphragm acoustic transducers as three sound signals. From the three sound signals corresponding to real 2D spatial sound produced by the configuration, different n-direction signals can be distinguished, wherein n is 8, for instance. The method and system can also be implemented in reverse for transfer or reproduction, in which case the corresponding signals—in this case from eight different directions—can be converted into three signals. With a configuration of three acoustic transducers according to one aspect of the invention, it is also possible to receive the signals on XYZ plane. On XYZ plane, the Z plane represents the elevation information, whereas the X and Y planes represent the information of the sound signal on the horizontal plane.

Another aspect of the invention is to provide a system and method, in which one dual-diaphragm acoustic transducer provides both an omni-directional and a figure-of-eight pattern simultaneously. The method and system can also be implemented in reverse for transfer or reproduction. Therefore, one aspect of the invention is to provide a configuration for a system and method, in which one acoustic transducer can receive or reproduce a combination of various directional pattern halves of both omni-directional and figure-of-eight patterns.

A further aspect of the invention is to provide a system and method, with which signals X, Y, and a signal W having an omni-directional pattern are generated for planar 2D spatial sound from signals received by a configuration of dual-diaphragm acoustic transducers.

Yet another aspect of the invention is to provide a system and method, with which signals X, Y, Z, and a signal W are generated for 3D spatial sound from signals received by a configuration of three dual-diaphragm acoustic transducers.

Yet another aspect of the invention is to provide a system and method, with which spatial sound on XY plane can be reproduced from signals X, Y, and W for planar spatial sound.

Yet another aspect of the invention is to provide a configuration for a system and method, with which 3D spatial sound can be reproduced from signals X, Y, Z, and W for planar spatial sound.

Yet another further aspect of the invention is to provide for reproduction a supplementary device related to the system and method of the invention, with which the head movements of a listener are taken into account when transferring a signal for reproduction in headphones.

Yet another further aspect of the invention is to provide a supplementary device related to the system and method of the invention, with which signals received with the configuration of acoustic transducers can be monitored in such a manner that the apparatus orients itself toward the signal source and follows it in accordance with predefined selection criteria.

Yet another further aspect of the invention is to provide a supplementary device related to the system and method of the invention, with which the directional patterns of the signals received with the configuration of acoustic transducers can be narrowed so as to separate a specific part for orientation.

According to one aspect of the invention, a method is provided for receiving acoustic signals for reproduction. In the method, acoustic signals are received with two dual-diaphragm acoustic transducers having a figure-of-eight directional pattern, which are directed perpendicular to each other on 2D plane while the directional patterns have directional pattern halves XA, XB and YA, YB, respectively. After this, first combination means generate a first signal X, wherein (X=XA−XB), and a second signal Y, wherein Y=(YA−YB), from the acoustic signals received by the acoustic transducers; in addition to this, second combination means generate an omni-directional signal Wₙ having an omni-directional pattern, wherein n {X, Y} and Wₙ is calculated by adding the directional pattern halves XA, XB and/or YA, YB of one or two signals in such a manner that two acoustic transducers having an figure-of-eight directional pattern provide simultaneously not only the first signal X and the second signal Y, but also the omni-directional signal Wₙ having an omni-directional pattern, so that by combining these three signals X, Y, Wₙ, a directed directional pattern pointing in the desired direction on 2D plane can be provided.

According to one aspect of the invention, a method is provided for receiving acoustic signals for reproduction. The method comprises receiving acoustic signals with three dual-diaphragm acoustic transducers having a figure-of-eight directional pattern, which are directed perpendicular to each other in 3D space, generating with first combination means from the acoustic signals received by the acoustic transducers a first signal X, a second signal Y, and a third signal Z, wherein Z=(ZA−ZB), respectively, and with second combination means an omni-directional signal Wₙ having an omni-directional pattern, wherein n {X, Y, Z} and Wₙ is calculated by adding the directional pattern halves of signals received by one, two, or three acoustic transducers in such a manner that three acoustic transducers having a figure-of-eight directional pattern provide simultaneously not only the first signal X, the second signal Y and the third signal Z, but also the omni-directional signal Wₙ having an omni-directional pattern, so that by combining these four signals X, Y, Z, Wₙ, a directed directional pattern pointing in the desired direction in 3D space can be provided.

According to one aspect of the invention, a method is provided for receiving acoustic signals for reproduction. The method comprises generating with second combining means a signal W_{xyz} having an omni-directional pattern, wherein (W_{xyz}=XA+XB+YA+YB+ZA+ZB), in such a manner that three acoustic transducers having a figure-of-eight pattern provide simultaneously not only the first signal X, the second signal Y and the third signal Z, but also the signal W_{xyz} having an omni-directional pattern.

According to one aspect of the invention, a method is provided for receiving acoustic signals for reproduction. The method comprising combining a generated first signal X and omni-directional signal Wₙ with two separate summing means so that in the first summing means the first signal X is added to the omni-directional signal Wₙ, and in the second summing means the first signal X is deducted from the omni-directional signal Wₙ, whereby the first signal X received by an acoustic transducer having a figure-of-eight directional pattern can be divided into two parts X_{front}, X_{back}; combining a generated second signal Y and the omni-directional signal Wₙ with two separate summing means so that in the first summing means the second signal Y is added to the omni-directional signal Wₙ, and in the second summing means the second signal Y is deducted from the omni-directional signal Wₙ, whereby the second signal Y received by an acoustic transducer having a figure-of-eight directional pattern can be divided into two parts Y_{right}, Y_{left}; processing the signal strength of the combined signal parts X_{front}, X_{back}, Y_{right}, Y_{left} in a signal processing block separately in accordance with predefined selection criteria; combining the different parts of the processed signals X_{front}, X_{back}, Y_{right}, Y_{left} to form numerical values PX, PY for the calculation of a directional angle; calculating the directional angle of a directional pattern on 2D plane on the basis of the numerical values PX, PY and the angle points in the direction of the provider of the acoustic signals processed according to the predefined selection criteria.

According to one aspect of the invention, a method is provided for receiving acoustic signals for reproduction. In the method, the product of the combination of the different parts X_{front}, X_{back} of the processed signals is a numeric value between −1 and +1, and the product of the combination of the different parts Yᵤₚ Y_{down} of the processed signals is reference information having the numerical value of 1 or 0, or vice versa, in which case the product of the combination of the different parts X_{front}, X_{back} of the signals is reference information having the numerical value of 1 or 0, and the product of the combination of the different parts Yᵤₚ, Y_{down} of the signals is a numerical value between −1 and +1, and when the product of the combination of the different parts X_{front}, X_{back} of the signals is a numerical value between −1 and +1, and the product of the combination of the different parts Yᵤₚ, Y_{down} of the signals is reference information having the numerical value of 1 or 0, the directional angle of the directed directional pattern is calculated with the formula:

Angle=ABS(SIN⁻¹(PX)+90+(PY*180).

According to one aspect of the invention, a method is provided for receiving acoustic signals for reproduction. The method comprising combining the third signal Z and omni-directional signal Wₙ with two separate summing means so that in the first summing means the third signal Z is added to the omni-directional signal Wₙ, and in the second summing means, the third signal Z is deducted from the signal Wₙ, whereby the third signal Z received by an acoustic transducer having a figure-of-eight directional pattern can be divided into two parts Zᵤₚ, Z_{down}.

According to one aspect of the invention, a method is provided for receiving acoustic signals for reproduction. The method comprising processing the signal strength of the combined signal parts Zᵤₚ, Z_{down} in a signal processing block separately in accordance with predefined selection criteria; combining the different parts Zᵤₚ, Z_{down} of the processed signals to form numerical values PZ, PZ for the calculation of a directional angle, in which the product of the combination of the different parts Zᵤₚ, Z_{down} of the processed signals is a numerical value between −1 and +1; calculating on the basis of the numerical values PZ, PZ a directional angle of the elevation direction of a directional pattern that points in the elevation direction of the provider of the acoustic signals processed according to the predefined selection criteria; and transmitting the acoustic signals according to the directional angle of the elevation direction of the directional pattern for transfer or reproduction.

According to one aspect of the invention, a method is provided for receiving acoustic signals for reproduction. In the method, information on the directional angle of the directed directional pattern is also transmitted for signal transfer or reproduction.

According to one aspect of the invention, a system is provided for receiving acoustic signals for reproduction. The system comprises two dual-diaphragm acoustic transducers with a figure-of-eight directional pattern that are perpendicular to each other on 2D plane while the directional patterns have directional pattern halves XA, XB and YA, YB, respectively; the system also comprises first combination means for generating from the acoustic signals received by the acoustic transducers a first signal X, wherein (X=XA−XB), and a second signal Y, wherein Y=(YA−YB). The system further comprises second combination means for generating an omni-directional signal Wₙ having an omni-directional directional pattern, wherein n {X, Y} and Wₙ is calculated by adding the directional pattern halves XA, XB and/or YA, YB of one or two signals in such a manner that two acoustic transducers having a figure-of-eight directional pattern provide simultaneously not only the first signal X and the second signal Y, but also the omni-directional signal Wₙ having an omni-directional pattern, so that by combining these three signals X, Y, Wₙ, a directed directional pattern pointing in the desired direction on 2D plane can be provided.

According to one aspect of the invention, a system is provided for receiving acoustic signals for reproduction. The system comprises three dual-diaphragm acoustic transducers with a figure-of-eight directional pattern that are perpendicular to each other on 3D plane while the directional patterns have directional pattern halves XA, XB, YA, YB, and ZA, ZB respectively. The system also comprises first combination means for generating from the acoustic signals received by the acoustic transducers a first signal X, a second signal Y, and a third signal Z, wherein Z=(ZA-ZB), respectively, and second combination means for generating an omni-directional signal Wₙ having an omni-directional directional pattern, wherein n {X, Y, Z} and Wₙ is calculated by adding the directional pattern halves of signals received by one, two or three acoustic transducers in such a manner that three acoustic transducers having a figure-of-eight directional pattern provide simultaneously not only the first signal X, second signal Y, and third signal Z, but also the omni-directional signal Wₙ having an omni-directional pattern, so that by combining these four signals X, Y, Z, Wₙ, a directed directional pattern pointing in the desired direction on 3D space can be provided.

According to one aspect of the invention, a system is provided for receiving acoustic signals for reproduction. The system comprises second combination means arranged to generate an omni-directional signal W_{xyz} having an omni-directional pattern, wherein (W_{xyz}=XA+XB+YA+YB+ZA+ZB), in such a manner that the three acoustic transducers having a figure-of-eight pattern provide simultaneously not only the first X, second Y and Z third signals having a figure-of-eight pattern, but also the signal W_{xyz} having an omni-directional pattern.

According to one aspect of the invention, a system is provided for receiving acoustic signals for reproduction. The system further comprises third summing means arranged to combine the generated first signal X and omni-directional signal Wₙ with two separate summing means in such a manner that the first summing means are arranged to add the first signal X to the omni-directional signal Wₙ, and the second summing means are arranged to deduct the first signal X from the omni-directional signal Wₙ, whereby the first signal X received by an acoustic transducer having a figure-of-eight directional pattern can be divided into two parts X_{front}, X_{back}. The system also comprises fourth summing means arranged to combine the generated second signal Y and the omni-directional signal Wₙ with two separate summing means in such a manner that the first summing means are arranged to add the second signal Y to the omni-directional signal Wₙ, and the second summing means are arranged to deduct the second signal Y from the omni-directional signal Wₙ, whereby the second signal Y received by an acoustic transducer having a figure-of-eight directional pattern can be divided into two parts Y_{right}, Y_{left}. The system has a signal processing block for processing the signal strength of the combined signal parts X_{front}, X_{back} and Y_{right}, Y_{left} in accordance with predefined selection criteria, a combination part combines the different parts X_{front}, X_{back} and Y_{right}, Y_{left} of the processed signals for calculating numerical values PX, PY for the computation of a directional angle. In the system, a calculation unit calculates on the basis of the numerical values PX, PY a directed directional angle of the directional pattern on 2D plane, which points in the direction of the provider of the acoustic signals processed according to the predefined selection criteria, and transmits the acoustic signals according to the directional angle of the elevation direction of the directed directional pattern for signal transfer or reproduction. The combination part can produce as the result of the combination of the processed signal parts X_{front}, X_{back} a numerical value between −1 and +1, and as the result of the combination of the processed signal parts Yᵤₚ, Y_{down} reference information having the numerical value of 1 or 0, or vice versa, in which case the product of the combination of the different signal parts X_{front}, X_{back} is reference information having the numerical value of 1 or 0, and the product of the combination of the different signal parts Yᵤₚ, Y_{down} is a numerical value between −1 and +1, and when the product of the combination of the different signal parts X_{front}, X_{back} is a numerical value between −1 and +1, and the product of the combination of the different signal parts Yᵤₚ, Y_{down} is reference information having the numerical value of 1 or 0, the directed directional angle of the directional pattern is calculated with the formula:

Angle=ABS(SIN⁻¹(PX)+90+(PY*180).

The system may further comprise fifth summing means which are arranged to combine the generated third signal Z and the omni-directional signal Wₙ with two separate summing means in such a manner that the first summing means are arranged to add the third signal Z to the omni-directional signal Wₙ and the second summing means are arranged to deduct the third signal Z from the omni-directional signal Wₙ, whereby the third signal Z received by an acoustic transducer having a figure-of-eight directional pattern can be divided into two parts Zᵤₚ, Z_{down}, and the signal processing block is arranged to process the signal strength of the combined signal parts Zᵤₚ, Z_{down} separately according to predefined selection criteria. A combination part is also arranged to combine the different parts Zᵤₚ, Z_{down} of the processed signals to form numerical values PZ, PZ for the calculation of a directional angle, in which the product of the combination of the different parts Zᵤₚ, Z_{down} of the processed signals is a numerical value between −1 and +1. A calculation unit also calculates on the basis of the numerical values PZ, PZ the directional angle of the elevation direction of the directed directional pattern that points in the elevation direction of the provider of the acoustic signals processed according to the predefined selection criteria, and transmits the acoustic signals according to the directional angle of the directed directional pattern for signal transfer or reproduction. The system can provide a conference microphone that points in the direction of the provider of the acoustic signals on the basis of the received signals of the directed directional pattern.

In accordance with an aspect of the present invention, two acoustic transducers having a figure of eight directional pattern, such as microphones, are provided perpendicularly relative to each other, enabling the reception of signals from different directions in the XY plane as three audio signals. The third signal is obtained by generating one W signal having an omni pattern from the received signals having a figure-of-eight directional pattern. Signals of several, e.g. eight, directions, can be separated from the three audio signals generated by the assembly. In accordance with one aspect of the invention, this operation can be implemented also inversely, whereby the corresponding eight signals of different directions can be transformed into three signals.

In accordance with another aspect of the present invention, three acoustic transducers having a figure of eight directional pattern, such as a microphone or a hydrophone, are provided perpendicularly relative to each other, enabling the reception of signals of different directions in the XY plane as three audio signals X, Y, W or in the XYZ plane, as four signals X, Y, Z and W. In the XYZ plane, the Z plane corresponds to elevation information, whereas X and Y correspond to audio signal information in the horizontal plane.

Furthermore, in accordance with an aspect of the present invention, an assembly of acoustic transducers is provided, enabling the reproduction of signals of different directions in the XY plane with two or alternatively three acoustic transducers, such as loudspeakers. In accordance with another aspect, the assembly of acoustic transducers also enables the reproduction of the signals in the XYZ plane. In this case, in accordance with an aspect, signals of the elevation plane (Z plane) can be reproduced with two different elements.

One additional aspect of the invention is to provide an assembly of acoustic transducers, wherein a filtration part is added to two transducers of the assembly. The purpose of this filtering part is to provide acoustic correction for the capsule of the acoustic transducer in the Z plane. The aim is to use this filtering part to prevent the attenuation of high frequencies from directions of about 45 degrees and 90 degrees. The filtering part is advantageous if the intention is to employ one of the capsules for creating an omni-patterned signal.

Still another aspect of the invention is to provide a system and a method for simultaneously generating both omni and figure-of-eight patterns from one dual-diaphragm acoustic transducer. For transfer or reproduction, the method is also implementable inversely. Thus, one aspect of the invention is to provide a system and a method for reproducing a combination of the directional pattern halves of an omni and a figure-of-eight directional pattern with one acoustic transducer.

Still another aspect of the invention is to provide a system and a method for generating signals X, Y and omni-signal W for planar spatial sound from signals received with dual-diaphragm acoustic transducers.

Still another aspect of the invention is to provide a system and a method for generating signals X, Y, Z and omni-signal W for spatial sound from signals received with three dual-diaphragm acoustic transducers.

Still another aspect of the invention is to provide a system and a method for reproducing spatial sound from signals X, Y and omni-signal W for planar spatial sound, observed in the XY plane.

Still another aspect of the invention is to provide a system and a method for reproducing spatial sound from signals X, Y, Z and omni-signal W for planar spatial sound.

Still another additional aspect of the invention is to provide a supplementary device associated with the arrangement and the method according to the invention for reproduction, with which movements of the listener's head are taken into account when a signal is being transmitted for reproduction.

Still another additional aspect of the invention is to provide a supplementary device associated with the signal of the arrangement and the method according to the invention for narrowing the directional patterns of a received signal to improve resolving power.

The desired sound material can be generated afterwards from a recording generated with the assembly of the invention for instance by monomixing, stereomixing, 5.1 mixing or other mixing, with which a selected number of signals can be included steplessly, since the assembly of acoustic transducer receives and transfers all acoustic signals from all directions for reproduction. An embodiment according to an aspect of the invention provides an acoustic transducer implementing the method, such as a microphone for receiving sound, enabling signals coming from different directions to be stored for reproducing spatial sound. An acoustic transducer may also be a loudspeaker for reproducing sound. The microphone or loudspeaker according to the invention comprises an acoustic transducer portion and an audio signal-processing portion.

The audio signal-processing unit comprises a separation/combination part, which may comprise combination and/or separation means. The units of an acoustic transducer, such as microphone capsules, are placed in the immediate vicinity of each other, and thus sound arrives at all capsules as simultaneously as possible. Such placement of microphones, a so-called one-point arrangement, enables transfer of accurate direction information. Utilization of such one-point technique enables signals to be subjected to summing and subtraction.

Still another object of the invention is to provide a microphone in a conference room, for example, as such a microphone utilizes the method of the invention and the equipment implementing the method in such a manner that the signals of the different directions are separated in accordance with the method. Signals received from different directions can be separated, compared and attenuated, if need be, allowing a conference microphone to separate/emphasize the sound source/speaker of one direction at a time, and thus the receiving party to the negotiation finds it easier to identify speech and the speaker.

Still another object of the invention is to provide an acoustic transducer, such as a loudspeaker, enabling the provision of spatial sound by employing three transducer units. Spatial sound is provided by combining the signals in accordance with the method of the present invention.

Still another aspect of the invention is to provide an acoustic transducer, such as headphones, for reproducing real spatial sound provided with the assembly of the invention. Spatial sound is provided by combining signals in accordance with the method according to the present invention to loudspeakers in the headphones. The headphones may be provided with a device for observing the movements of the listener's head. A supplementary device enables the provision of binaural recordings in real time such that the head movements are fed into a signal processor, which calculates the changes caused in the movement at the HRFT (Head Related Transfer Function).

The placement of microphones according to an aspect of the invention enables the provision of a microphone for instance in a conference room, whereby the microphone utilizes the method of the invention and the equipment implementing the method such that signals of different directions are separated in accordance with the invention. In this case, signals received from different directions can be separated, compared and attenuated, if need be, allowing a conference microphone to separate/emphasize the sound source/speaker of one direction at a time, and thus the party receiving the conference finds it easier to identify speech and the speaker. The microphones may be dual-diaphragm microphone capsules, known per se, whose small capsular structure allows the arrangement to be made compact. A new kind of capsule arrangement enables similar reproduction from all directions. The reproduction of the microphones may be corrected electrically or acoustically. The coupling arrangement of the invention enables the simultaneous use of dual-diaphragm microphone elements as a figure of eight containing a directional pattern having two directional pattern halves and circular, this enabling determination of the exact position of the sound source according to the invention.

An embodiment of the invention provides an acoustic transducer employed in an underwater acoustic field and having a simple structure, a hydrophone. The hydrophone may comprise a diaphragm employed according to the magnetostatic, electrostatic or piezo principle. The assembly according to the embodiment of the invention is suitable both as a transmitter and as a receiver, a depth sounder, for example.

In accordance with an embodiment of an aspect of the invention, there is provided an acoustic transducer, such as a loudspeaker, for providing spatial sound with three units. Signals are combined into the loudspeaker in accordance with the present method. This allows five or eight loudspeakers to be replaced with three loudspeaker units. In this case, the loudspeakers may be normal conical elements or planar dipole loudspeakers, for example. The loudspeaker radiates at the back backwards in the same manner as forward, but in an opposed phase. In this case, audio signals in the XY plane are reflected to the listener via walls. To emphasize the elevation direction, signals in the Z elevation plane can be repeated with two different elements. The loudspeaker elements may also be dual-diaphragm, in which case pressure shall be conducted from between the diaphragms into a separate space, an enclosure, for example. Said microphone assembly is capable of generating four signals, which may be combined by previously known (MS, Blumlein and Ambisonics) methods at different ratios and polarities. The signals generated with the arrangement and method enabled by the assembly are compatible with said formats, and particularly with the Ambisonics B format.

Accordingly, the assembly of acoustic transducers accomplishes a compact microphone. As few as two small figure-of-eight capsules achieve an 8.1 surround microphone, for example. The new assembly of acoustic transducers is advantageous and easy to manufacture, since the structure of one capsule is known. The utilization of the structure in a new manner enables an acoustically well operating surround microphone, since the time and transfer function differences of the capsules are minimal. A 2D or 3D Surround microphone has good dynamics, since the diaphragms of the capsules may be sufficiently large without compromising said advantage. For its operation, the new system does not require frequency, phase or other electrical compensations and thus sound quality remains as authentic as possible.

### BRIEF DESCRIPTION OF THE FIGURES

In the following, the invention will be described in more detail in connection with preferred embodiments with reference to the accompanying drawings, in which

FIG. 1A shows an embodiment of the structure and placement of acoustic transducers;

FIG. 1B shows another embodiment of the structure and placement of acoustic transducers;

FIG. 2A shows an embodiment wherein additional elements for filtering are arranged in the acoustic transducers of FIG. 1A;

FIG. 2B shows a sectional view of the principle of the filtering of the additional elements of the acoustic transducers shown in FIG. 2A;

FIG. 3 shows a coupling diagram for achieving an omni pattern and a figure-of-eight pattern from a capsule having one dual diaphragm;

FIG. 4A shows a coupling diagram of an embodiment for achieving four signals from a capsule having three dual diaphragms;

FIG. 4B shows a coupling diagram of an embodiment for achieving three signals from two capsules having two dual diaphragms;

FIG. 4C shows a coupling diagram of an embodiment for achieving three signals from three capsules having a dual diaphragm;

FIG. 5 shows the directional pattern of a Y unit in a direction to the left-right;

FIG. 6 shows the directional pattern of an X unit in a direction forward-backward;

FIG. 7 shows an omni-patterned directional pattern calculated in accordance with the coupling of the embodiment of FIG. 4A;

FIG. 8 shows the directional pattern of a signal calculated in accordance with the coupling of the embodiment of FIG. 4B in a 45-degree direction;

FIG. 9 shows the directional pattern of a signal calculated in accordance with the coupling of the embodiment of FIG. 4B in a 270-degree direction;

FIG. 10 shows a diagram of an embodiment for orienting a signal in direction XYZ;

FIGS. 11 to 13 are examples of directional patterns oriented in accordance with the diagram of the embodiment according to FIG. 10 in direction XYZ;

FIG. 14A shows an embodiment of a conference microphone for receiving sound, wherein three persons are speaking at the same time;

FIG. 14B shows a situation wherein the device according to an embodiment of the invention has separated and emphasized the sounds of one person only from the situation of FIG. 14A;

FIG. 15 shows an embodiment of a loudspeaker of an acoustic transducer according to the invention;

FIG. 16 shows an embodiment wherein the loudspeaker of FIG. 15 is placed in a room;

FIG. 17 shows an embodiment of the headphones of an acoustic transducer.

FIG. 18A shows an embodiment of the invention for orienting signal reception or reproduction.

FIG. 18B shows an embodiment wherein the steps of FIG. 18A are implemented for two signal pairs for further orienting reception and reproduction.

### DETAILED DESCRIPTION OF THE INVENTION

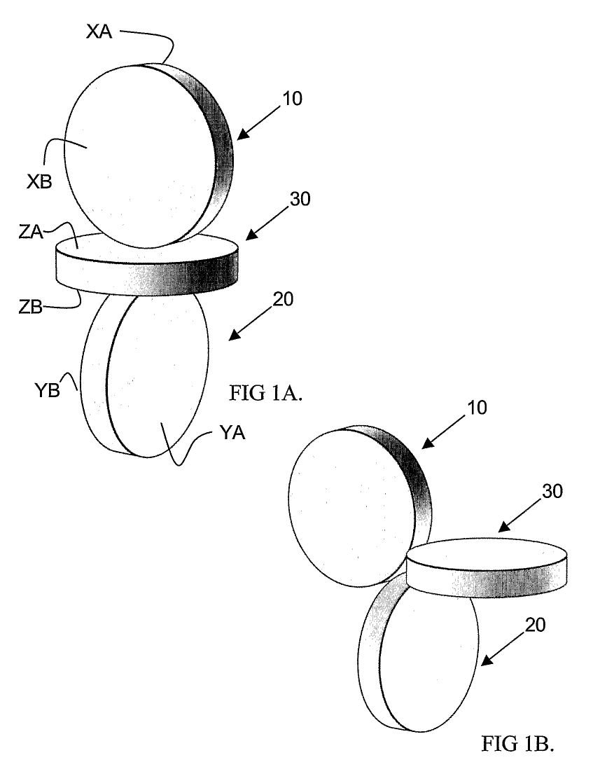

FIG. 1A shows an embodiment of the structure and placement of an assembly of acoustic transducers. The assembly comprises three superimposed acoustic transducers 10, 20, 30 for receiving and reproducing acoustic signals, the first acoustic transducer 10 having a figure-of-eight directional pattern in the horizontal forward/backward direction (herein, in the direction of the X coordinate axis) and including directional pattern halves XA, XB. The second acoustic transducer 20 has a figure-of-eight directional pattern in the horizontal direction right-left (in the direction of the Y coordinate axis), including directional pattern halves YA, YB. The third acoustic transducer 30 has an upward/downward directional pattern in the direction of the Z coordinate axis, having a circular form when observed in the XY plane and including directional pattern halves (ZA, ZB). In the assembly, the centre points are as close to each other as possible and yet they cover as little of each other as possible. The angles between the acoustic transducers are 90 degrees. Preferably, the acoustic transducers 10, 20, 30 may be dual-diaphragm microphone capsules, in which case the directional pattern halves XA, XB, YA, YB, ZA and ZB are provided with separate diaphragms. The assembly of the invention for receiving acoustic signals may also be used for implementing a hydrophone. In signal reproduction, the acoustic transducers may be loudspeaker elements.

FIG. 1B shows another embodiment of the structure and placement of an assembly of acoustic transducers 10, 20, 30. In this case, the acoustic transducers are placed adjacently in such a manner that the surface of the periphery of each transducer is in the immediate vicinity of the outer surface of the other two capsules. This assembly allows the distance between the axes of revolution of the acoustic transducers, such as microphones or loudspeakers, to be made small and, simultaneously, the distances between them are equal.

In the previous embodiments, three acoustic transducer units are assembled adjacently in such a manner that, in the case of a microphone, sound arrives at all units as simultaneously as possible and, in the case of a loudspeaker, sound is transferred away from the unit as simultaneously as possible. In the utilization of such one-point technique, signals can be submitted to summing and subtraction.

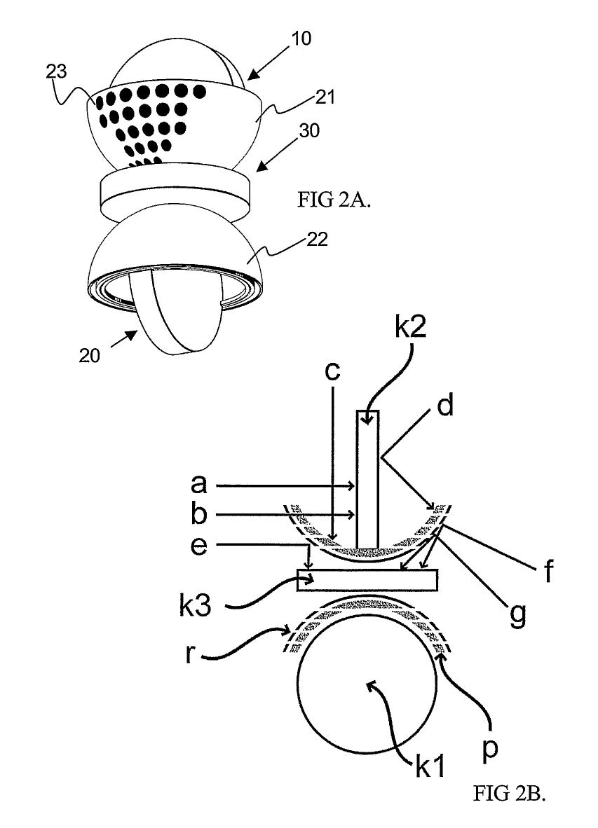

FIGS. 2A and 2B show an embodiment wherein filtering parts 21, 22 for filtering are arranged in the acoustic transducers of FIG. 1A. In the figure, the filtering parts are arranged in the uppermost and lowermost acoustic transducer. The filtering parts 21, 22 have a curved shape, which settles at least partly on top of the acoustic transducer. Herein, the filtering parts 21, 22 have a hemispherical shape, but its elevation and curvature may be changed for achieving the desired filtering or attenuation characteristics. The outer surface r of the curved filtering part is arranged to reflect signals to the acoustic transducer in the middle, and its inner surface is arranged to attenuate the reflections of signals hitting it. The attenuating material p may be a material that transforms acoustic energy into thermal energy. The wall of the filtering part 21, 22 is provided with signal-permeable openings 23, which are depicted in the upper acoustic transducer of FIG. 2A. The purpose of the filtering part is to improve the hits of the signals into the correct acoustic transducer, the transducers being placed as closely as possible in accordance with the invention.

FIG. 2B shows a partial sectional view, showing the operating principle of the filtering parts of the acoustic transducers shown in FIG. 2A. Signals e, f and g are reflected into capsule k3 of the middle acoustic transducer. Signal a hits the uppermost capsule k2. Signal b hits capsule k2 through the opening 23 shown in FIG. 2A. Signal d, arriving obliquely from above, is reflected from capsule k2 and then hits the attenuating material p of the filtering part 21. The attenuating material p and the reflecting outer surface r are denoted in the filtering part 22 of capsule k1.

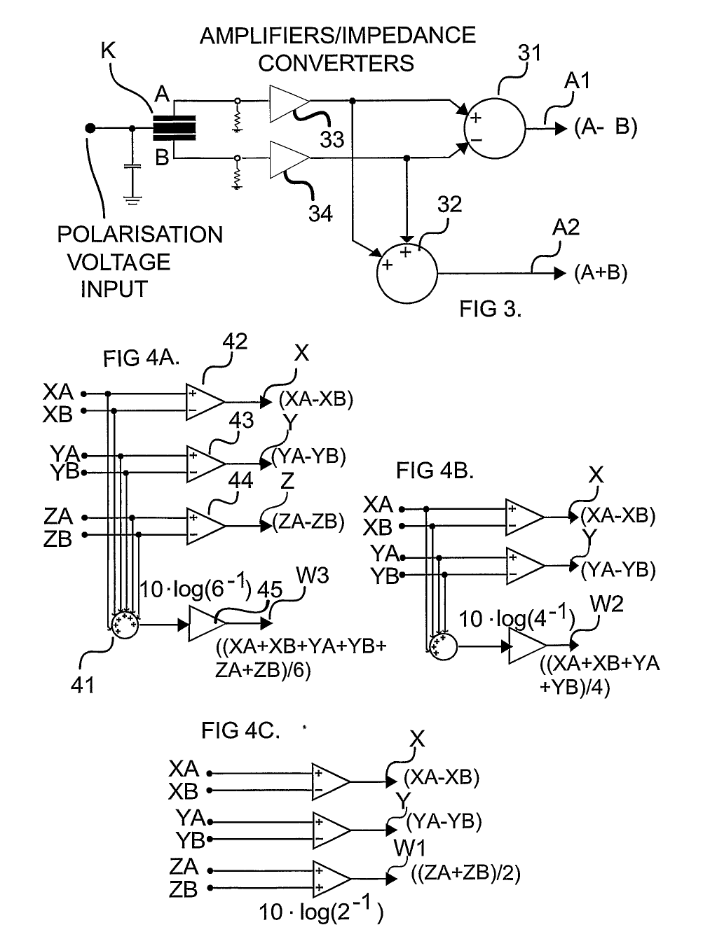

FIG. 3 shows a coupling diagram for simultaneously achieving an omni pattern and a figure-of-eight pattern from one microphone capsule of an acoustic transducer having a dual diaphragm. Polarization voltage input is generated at capsule k with an external power source. Capsule k has two diaphragms A and B, whose signals are separately fed into separate amplifiers (Amplifiers/impedance converters) (33, 34). The signals are then summed with combining means 31, with which a first signal A−B is obtained. Any electrical, external interference in this signal having a figure-of-eight directional pattern are cancelled out in connection with the subtraction. The coupling of FIG. 3 enables the simultaneous summing of signals with a second combining means 32, in order to obtain a second signal A+B, which has an omni directional pattern. In the summing of signals A, B, the interferences in the signals are also summed up, but, on the other hand, this interference is reduced if the omni signals of a plurality of microphone capsules are summed up. In 2D and 3D embodiments, the signals of 1 to 3 capsules maybe used for generating an omni signal. With this arrangement, 2D spatial sound is achieved with two only two capsules. For 3D spatial sound, a third microphone capsule providing elevation information is required.

FIG. 4A shows a coupling diagram of an embodiment for achieving four signals from three capsules having a dual diaphragm. From the signals provided by the three capsules, all signal differences are taken and amplified with amplifiers 42, 43 and 44 into signals X, Y and Z. A sum is taken from all signals with summing means 41, and the sum is then scaled with an amplifier 45 to correspond to the other outputs. Herein, signal W3 obtained with the summing means 41 is an optimal signal having an omni pattern, since it takes a signal from all capsules and all directions. The amplifiers 42, 43, 44 should be balanced. Signal W3 can be alternatively also calculated only by summing up and scaling the signals of only one capsule or two capsules, e.g. XA+XB+ZA+ZB.

FIG. 4B shows a coupling diagram of a 2D embodiment for achieving three signals X, Y and W2 from two capsules having a dual diaphragm. The vertical direction is omitted from this embodiment. Such a 2D embodiment is usable for instance in video cameras or other corresponding devices for recording spatial sound.

FIG. 4C shows a coupling diagram of an embodiment for achieving three signals X, Y and W1 from three capsules having a dual diaphragm. Herein, the elevation-direction capsule exists, but it is only employed in providing an omni-pattern signal. In the example, only signals ZA and ZB are summed up, but in addition, one or both of signal pairs XA, XB and YA, YB could equally well be summed up.

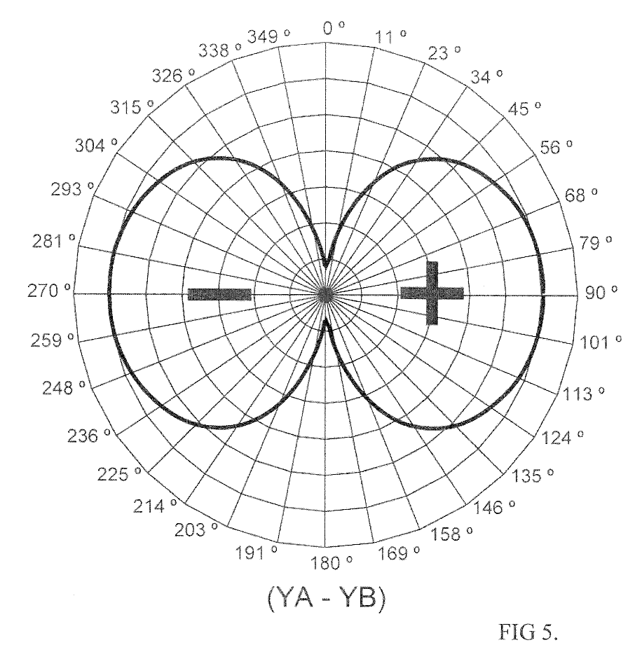

FIG. 5 shows the directional pattern of unit Y in the left-right direction. In the directional pattern, the positive directional pattern half YA is on the right and the negative directional pattern half YB is on the left.

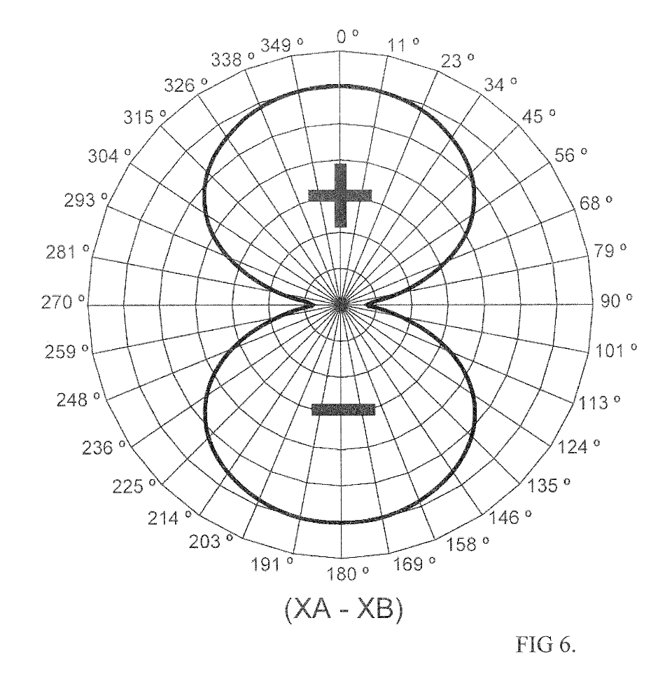

FIG. 6 shows a directional pattern of unit X in the backward/forward direction. In the directional pattern, the positive directional pattern half XA is on top and the negative directional pattern half XB is underneath.

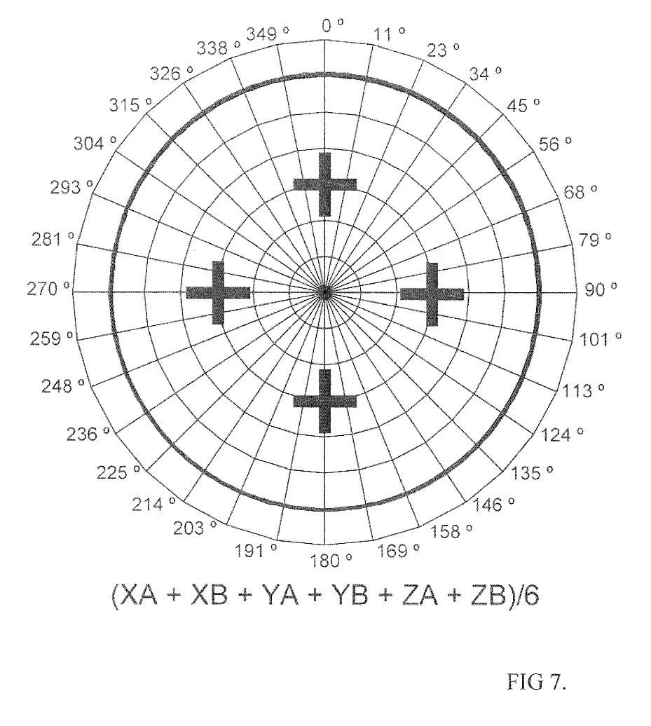

FIG. 7 shows the directional pattern of an omni signal, calculated in accordance with the coupling of the embodiment according to FIG. 4A, wherein the signals of three acoustic transducers are summed up.

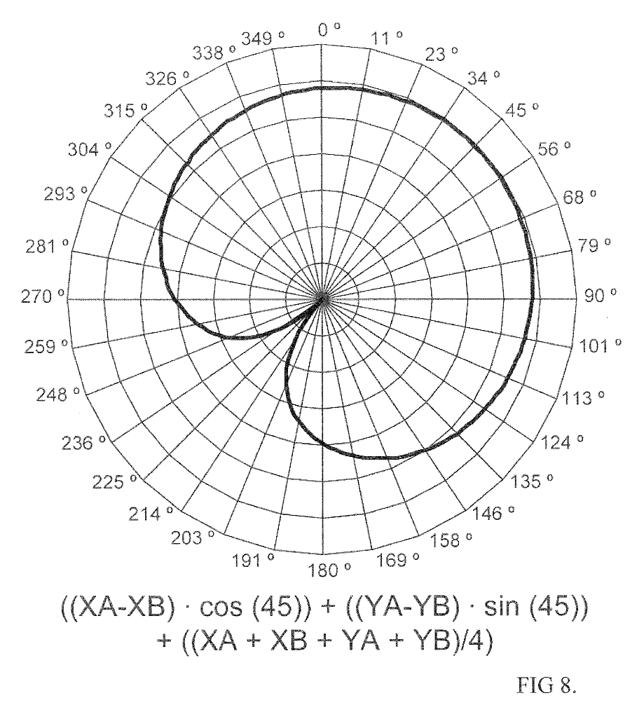

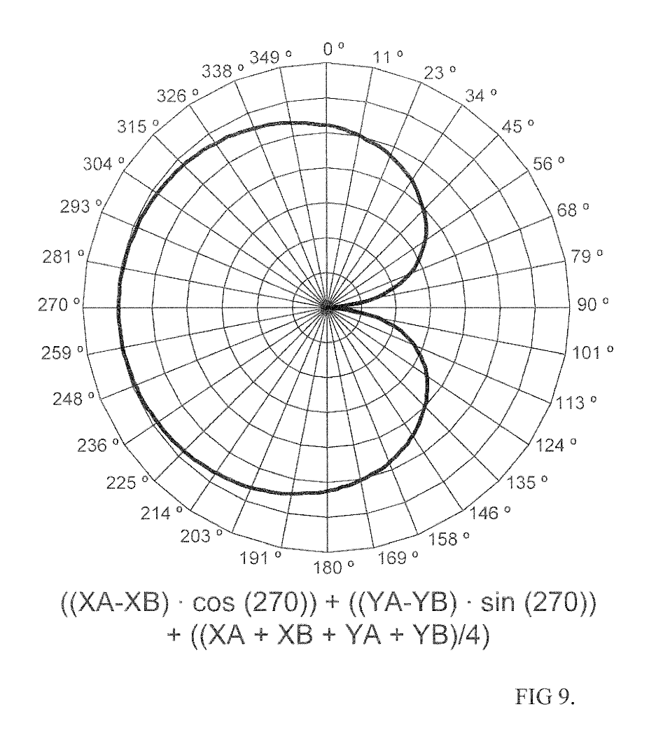

FIG. 8 shows the directional pattern of an oriented signal, calculated in accordance with the coupling of the embodiment according to FIG. 4B, in a 45-degree direction. It can be seen from the figure that the calculated signal has a cardioid pattern, which is a so-called orienting pattern. Such a microphone with a cardioid pattern effectively picks sounds in a given direction and on the sides of said direction, but leaves sounds coming from behind silent. FIG. 9 shows the directional pattern of a signal, calculated in accordance with the coupling of the embodiment according to FIG. 4B, in a 270-degree direction.

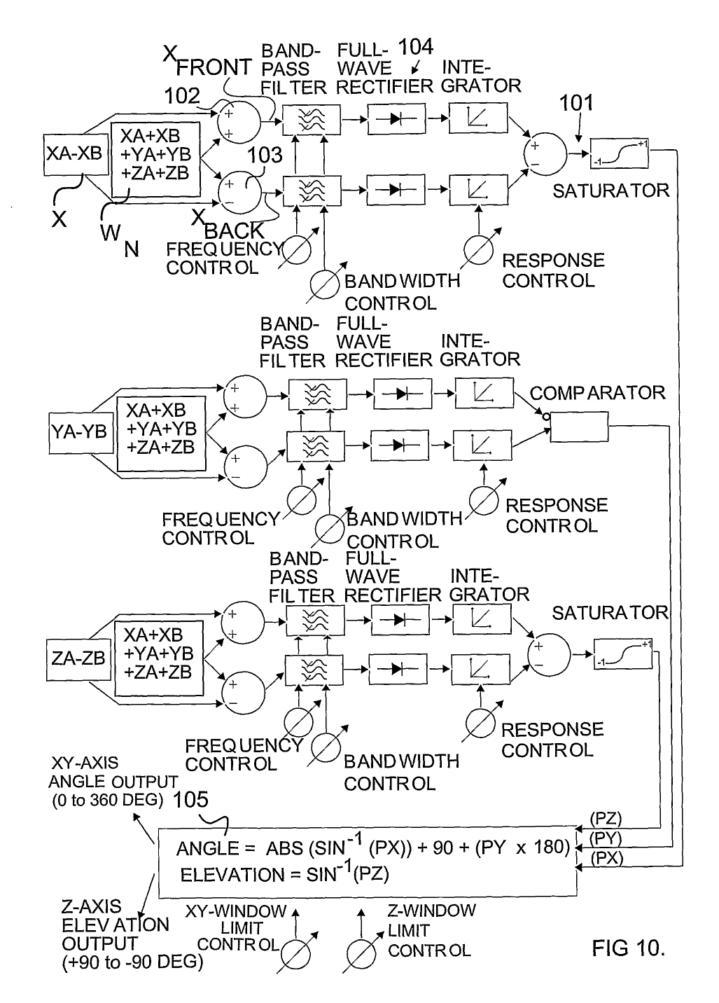

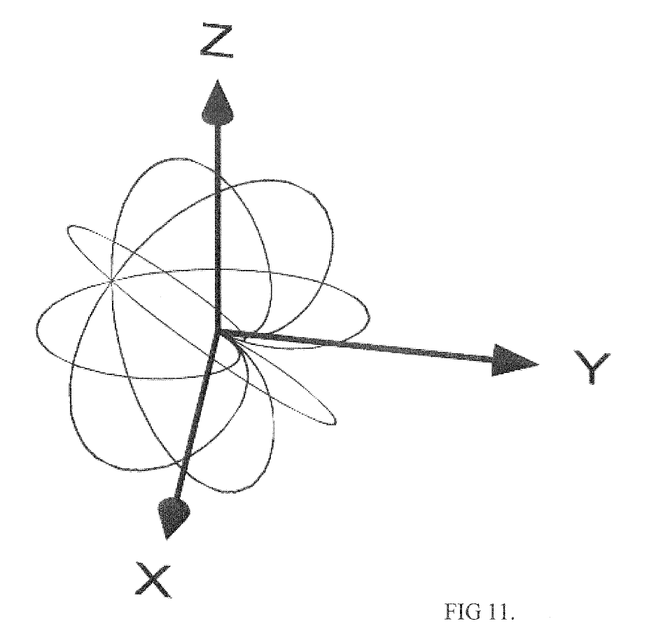

FIG. 10 shows a diagram of an embodiment for orienting a signal in the XYZ direction. In accordance with the diagram, a band-pass filter can be used to select the frequencies of the sound to be received. The frequencies can be restricted with a frequency controller in such a manner than for instance sounds generated by-passing cars can be eliminated. With a bandwidth controller, the device can be set to let through the width of the speech frequency range, for example.

The signal is then rectified with a full wave rectifier and integrated with an integrator. A response controller can be used to control the reaction of the microphone to the change. The response controller may adjust the time constant, composed of attack speed to new sounds, and the delay of giving up the current direction. The time constant can be used to adjust for instance the reaction of the device to sudden sounds, to a sudden coughing sound, for example.

The signals are then summed up with summing means 101. If a signal comes from the front, then the signal is positive. Contrarily, when a signal comes from behind, the signal is negative. The signal is calculated in the same way in the elevation direction. When a signal comes from above, the result of the addition is positive and negative if it comes from below. In addition, the device comprises a saturator, with which a value between −1 to +1 is obtained for the calculation.

Herein, block Y is similar, but instead of summing means and saturator, it includes a comparator for deciding if the signal is on the left or on the right. An abrupt decision is made herein to simplify angle calculation, this, however, not significantly weakening the accuracy of the result. In this case, the comparator transfers the signal to the other side at a predetermined point. This direction X and Y assembly enables direction determination between 0 and 360 degrees. It should be borne in mind that the structure of blocks X and Y may also be implemented inversely, whereby the comparator is situated in the block of signal X.

Direction calculation is implemented in a calculation unit 105. The angle is calculated by the formula: Angle=ABS(SIN⁻¹)PX+90+(PY*180). The elevation is calculated by the formula: Elevation=(SIN⁻¹)ZX. In addition, the calculation unit 105 may comprise a direction XY window limit control unit and a Z window limit control unit. The XY window limit control unit may be used for instance to remove all signals coming from the back and the Z window limit control unit can be used to limit signals coming from the direction of a given elevation direction, more than 45 degrees, for example.

This assembly enables simple implementation, with sufficient accuracy, of a sound-following microphone that simulates the operation of the human ear. The device is usable for instance in video cameras, conference microphones or the like. In interview situations and conference situations, the device is capable of following the person who is speaking. This is realized also in the elevation direction, which is a problem when the speakers are of different heights or at different heights. The operation of the device is implementable also inversely for reproduction.

The device listens to all directions and determines the direction from which the sound is coming and indicates this direction. Using suitable settings, the device is usable also for surveillance. In this case, the device follows the sound source and may produce the sound source direction information also for use by another device. In this case, this direction information can be utilized for instance for controlling the direction of a surveillance camera, allowing one camera to be used for accurately monitoring even large spaces.

The device can be used for processing sound recorded with an acoustic transducer according to the invention. The device is preferably utilizable also for further processing of sound tracks, such as the sound track of a movie. With further processing, the voices of different people can be separated into different sound channels. Out of the signals generated by the into different sound channels. Out of the signals generated by the device, the object of the desired direction can be separated and it can be emphasized by removing extra sounds associated with said direction. Accordingly, the sound produced by a given person or object can be separated to a separate sound channel, for example. In further processing, said device can also be used to make an override action for the recording for instance in a situation when the microphone starts to follow another sound source, a bypassing car, for example. Identification is made according to strength, but it may also be made by using some other selection criterion.

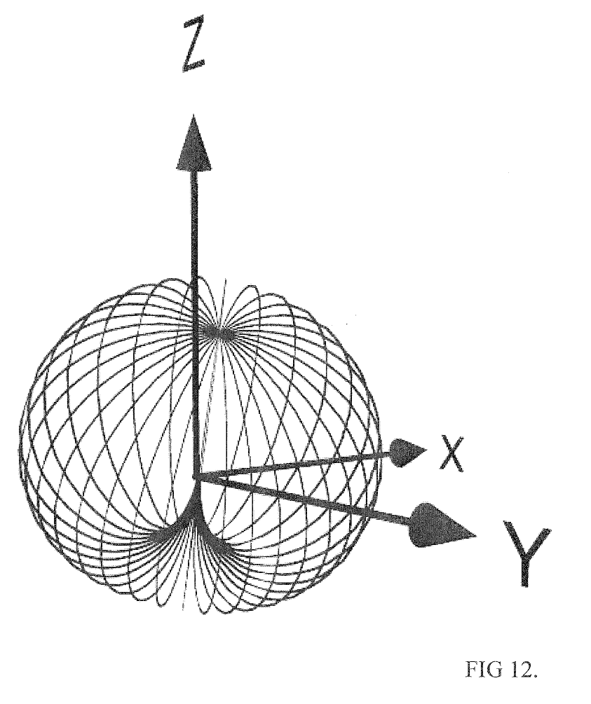

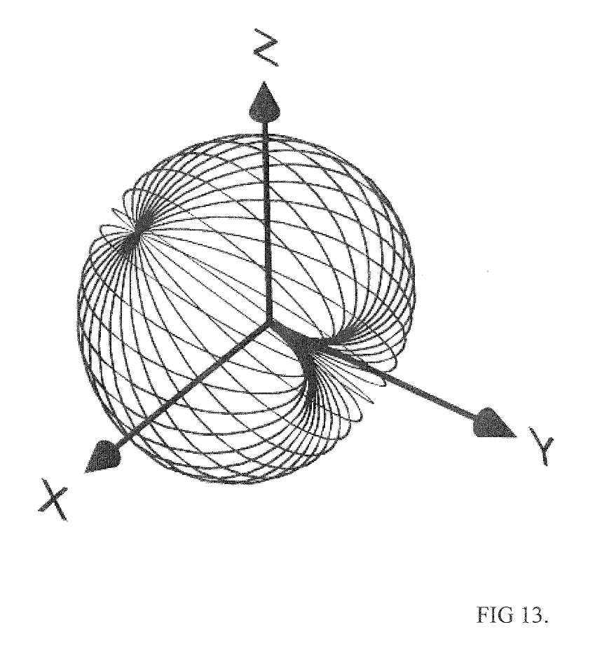

FIGS. 11 to 13 are examples of the directional patterns of the device according to the embodiment of FIG. 10 in direction XYZ.

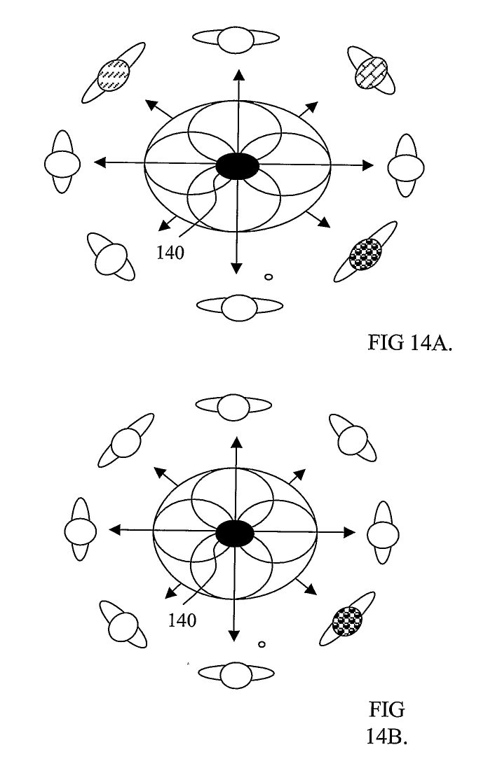

FIG. 14A shows a situation of sound reception for instance in a conference when three persons are speaking simultaneously. FIG. 14B shows a situation when a device 140 of the invention according the embodiment of FIG. 10 has separated and emphasized the sounds of one person only from the situation of FIG. 14A. Such a microphone is usable in teleconferences or videoconferences, for example. The device 140 comprises two or three microphones for receiving three signals. Three signals are separated with combination means into eight signals of different directions, for example, which are compared on the basis of a predetermined rule, volume, for example. Accordingly, the direction from which most signals or the strongest signal is coming is identified. Signal processing attenuates a weaker signal and emphasizes the selected signal. This being so, the signals may be separated from each other and the separation can be improved without all participants having to have a separate microphone.

FIG. 15 shows a 2D embodiment of the loudspeaker of an acoustic transducer according to the invention. Loudspeaker elements 151, 152 of directions X and Y are superimposed perpendicularly relative to each other. Herein, elements W (omni) are divided into an upper element 153 and a lower element 154. Elements W may also be employed for reproducing low frequencies. Accordingly, signal processing may be performed inversely when the acoustic transducer is a loudspeaker. In this case, signals intended for five or eight loudspeakers can be implemented with two, three or four loudspeaker element with the loudspeaker according to the invention.

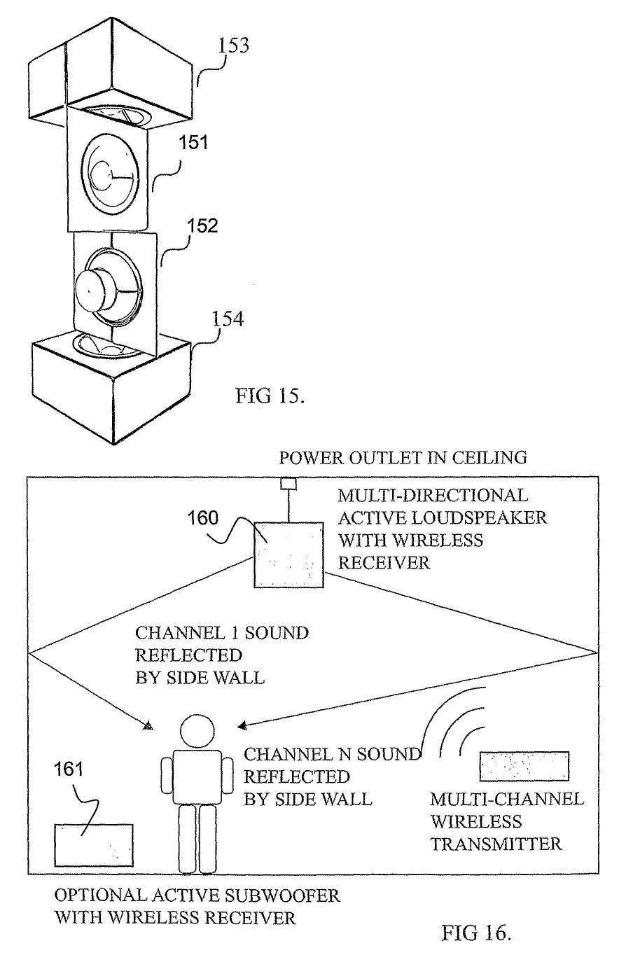

FIG. 16 shows an embodiment wherein the loudspeaker of FIG. 15 is placed in a room. The signals to be reproduced are transmitted with a multi-channel wireless transmitter to a loudspeaker assembly 160 and to a subwoofer 161 intended for reproducing low frequencies. Receivers arranged in connection with the loudspeaker receive the signals and reproduce them. The figure illustrates how signals are reflected via walls to the listener, thus creating an impression of spatial sound. A signal (X.1) having low frequencies is separated from the signal received in accordance with the embodiment by using a filtering means (LFE), which is arranged to separate the signal (X.1) having low frequencies. The low-frequency signal can be reproduced with a separate subwoofer 161 intended for reproducing low frequencies. The loudspeaker may further comprise a light source (not shown), whereby power intended for an illuminator may be utilized. This is advantageous particularly when a signal is transferred wirelessly on three channels. In this case, the loudspeaker unit comprises a receiver unit for also receiving control of a remote control. This being so, the remote control (not shown) can be used to control the illumination and the strength of the audio signals. The same remote control can also be utilized for controlling light.

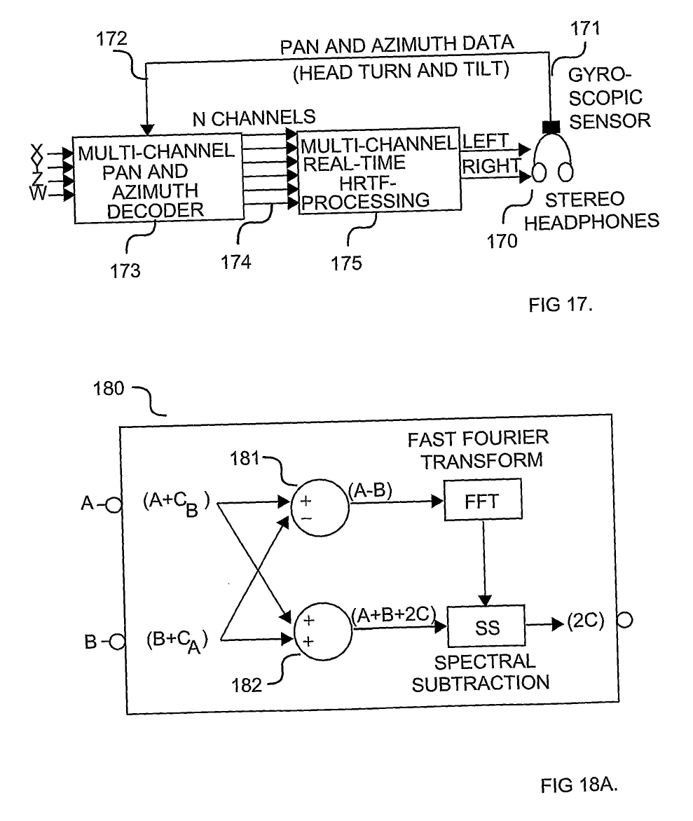

FIG. 17 shows an embodiment wherein the signals of the method according the invention are provided in headphones 170. Signals X, Y, Z and W, generated in accordance with the invention, are processed in a signal processing unit 173, a decoder, for example. The signal processing unit 173 is arranged to receive spatial information 172 received by a gyroscopic sensor 171 in the headphones. The spatial information 172 may comprise location and tilt information relative to a given reference point. The multi-channel pan and azimuth decoder 173 receives both sets of information and generates an n-channel 174, for instance a 26-channel, signal of different directions for an HRFT unit 175. The purpose of measurement-based HRFT processing is to generate sound corresponding to the behaviour of the ear for the headphones. Of these signals, representative of real spatial sound, the HTRF unit generates signals right and left to the right and left headphone of the listener, which signals provide spatial sound to the listener via the headphones 170. This arrangement provides the listener with not only excellent spatial sound but also a virtual sound scenery, which adapts itself in accordance with the movements of the listener's head. For example, the song of a solo singer heard from the television is always heard from the direction wherein the image source is situated, even if the listener were positioned at the edge of a room or if the head of the listener were turned to another direction. Such a sound scenery is particularly advantageous for simulation purposes, for instance in computer advantageous for simulation purposes, for instance in computer games, when a wide screen, several screens or an eye screen is used.

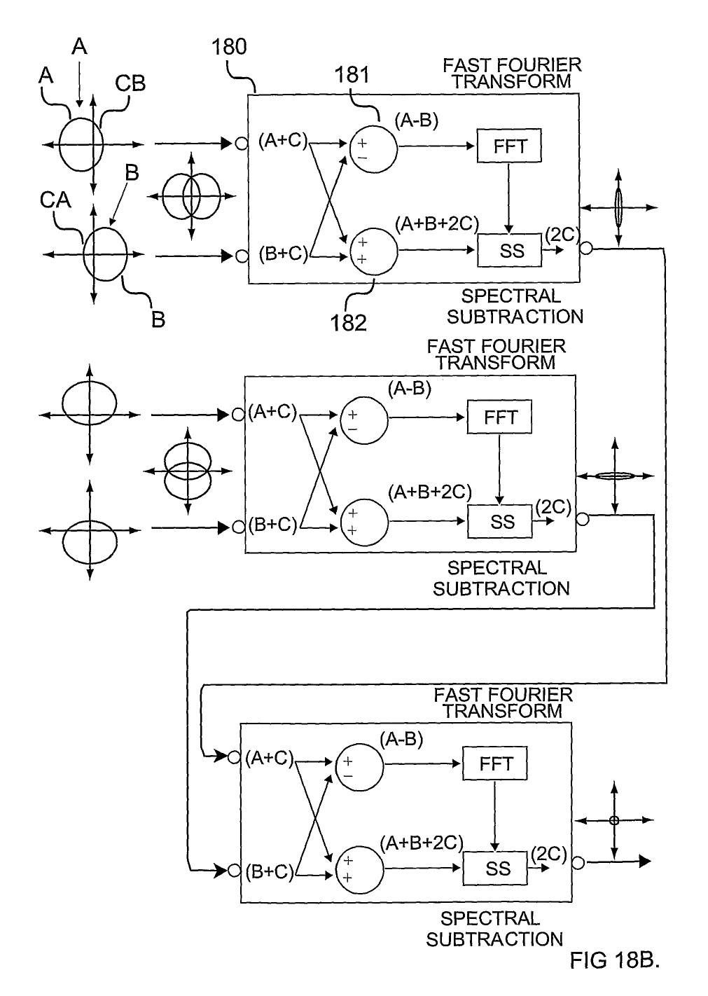

FIG. 18A shows an embodiment of the invention for orienting signal reception or reproduction. Here, signals A and B are received with an acoustic transducer according to the invention, from where the signals are fed to an orientation supplementary device. Two channels A and B are fed to the orientation device 180, of which one contains A and C_{B}, which is common with B. The second channel contains B and C_{A}, which is common with A.

The signals are combined in a first summing means 181 by subtracting (B+C_{A}) from (A+C_{B}). The common signal portion C is thus cancelled out and signal (A−B) is obtained as a result of the combination.

Frequency transformation is then performed in an FFT unit (Fast Fourier Transform), wherein the transform coefficients represent the signal in the frequency dimension. In signal processing, such a frequency trans-formation can be implemented for instance by using the Fast Fourier Trans-formation (FFT) algorithm.

At the same time, signals (A+C_{B}) and (B+C_{A}) are combined in a second summing means 182. Signal (A+B+2C) is obtained as a result. Signal (A+B+2C) is then input into a digital SS (Spectral Subtraction) filter having equally narrow frequency bands as those in the FFT unit. These frequency bands are attenuated according to information obtained from the FFT unit, whereby common C parts (C_{A}, C_{B}) are obtained from A and B. This C part can now be utilized in directing the orientation. A narrowed directional pattern is obtained as a result, whereby two signals provided by an acoustic transducer according to the invention can be used with this solution to provide an oriented point-like directioning, even if signals were received from an acoustic transducer having a wide directional pattern. FIG. 18A shows an embodiment, wherein the method according to FIG. 18A is implemented for signals received by two acoustic transducers. The method is implemented in accordance with FIG. 18A for the signals of two directions, directions XY, for example. The C parts obtained as a result are once more subjected to the method steps of FIG. 18A, whereby the result obtained is a still more oriented C part.

It is obvious to a person skilled in the art that as technology advances, the basic idea of the invention can be implemented in a variety of ways. Consequently, the invention and its embodiments are not restricted to the above examples, but can vary within the scope of the claims.

1. A method for receiving acoustic signals for reproduction, comprising:
receiving acoustic signals with two dual-diaphragm acoustic transducers capable of providing a figure-of-eight directional pattern and are directed on two-dimensional plane perpendicularly to each other with the directional patterns having directional pattern halves (XA, XB) and (YA, YB) respectively,
generating a first signal (X), wherein (X=XA−XB), and a second signal (Y), wherein Y=(YA−YB), with first combination means from the acoustic signals received by the dual-diaphragm acoustic transducers,
generating with second combination means an omni-directional signal (Wn) having an omni-directional pattern, wherein n {X,Y}, in which (Wn) is calculated by adding together the directional pattern halves (XA, XB) and/or (YA, YB) of one or two signals in such a manner that the two dual-diaphragm acoustic transducers provide simultaneously not only the first signal (X) and the second signal (Y), but also the omni-directional signal (Wn) having an omni-directional pattern, and with the combination of the three generated signals (X, Y, Wn), it is possible to provide a directed directional pattern pointing in the desired direction on two-dimensional plane.

2. A method as claimed in claim 1, wherein the method comprising
receiving acoustic signals with three dual-diaphragm acoustic transducers that are capable of providing a figure-of-eight directional pattern and are directed in three-dimensional space perpendicular to each other,
generating a first signal (X), a second signal (Y), and a third signal (Z), wherein Z=(ZA−ZB), with first combination means from the acoustic signals received by the acoustic transducers, and
generating with second combination means an omni-directional signal (Wn) having an omni-directional pattern, wherein n {X,Y,Z}, in which (Wn) is calculated by adding together the directional pattern halves of one, two or three signals received by the dual-diaphragm acoustic transducers in such a manner that the three dual-diaphragm acoustic transducers provide simultaneously not only the first signal (X) and the second signal (Y) and the third signal (Z), but also the omni-directional signal (Wn) having an omni-directional pattern, and with the combination of the four generated signals (X, Y, Z, Wn), it is possible to provide a directed directional pattern pointing in the desired direction in three-dimensional space.

3. A method as claimed in claim 2, wherein
the second combination means generate an omni-directional signal (WXYZ) having an omni-directional pattern, wherein (WXYZ=XA+XB+YA+YB+ZA+ZB), in such a manner that the three dual-diaphragm acoustic transducers provide simultaneously not only the first signal (X) and the second signal (Y) and the third signal (Z), but also the omni-directional signal (WXYZ) having an omni-directional pattern.

4. A method as claimed in claim 1, wherein
combining the first generated signal (X) and the omni-directional signal (Wn) with two separate summing means in such a manner that in the first summing means the first signal (X) is added to the omni-directional signal (Wn), and in the second summing means the first signal (X) is deducted from the omni-directional signal (Wn), whereby the first signal (X) received by an dual-diaphragm acoustic transducer capable of providing a figure-of-eight directional pattern can be divided into two parts (Xfront, Xback),
combining the second generated signal (Y) and the omni-directional signal (Wn) with two separate summing means in such a manner that in the first summing means the second signal (Y) is added to the omni-directional signal (Wn), and in the second summing means the second signal (Y) is deducted from the omni-directional signal (Wn), whereby the second signal (Y) received by an dual-diaphragm acoustic transducer capable of providing a figure-of-eight directional pattern can be divided into two parts (Yright, Yleft),
processing the signal strength of the combined signal parts (Xfront, Xback) and (Yright, Yleft) in a signal processing block separately in accordance with predefined selection criteria,
combining the different parts (Xfront, Xback) and (Yright, Yleft) of the processed signals to form numerical values (PX, PY) for the calculation of a directional angle,
calculating on the basis of the numerical values (PX, PY) the directional angle of a directional pattern directed on two-dimensional plane, which points in the direction of the provider of the acoustic signals processed according to the predefined selection criteria.

5. A method as claimed in claim 4, wherein
the product of the combination of the different parts (Xfront, Xback) of the processed signals is a numerical value between −1 and +1, and the product of the combination of the different parts (Yup, Ydown) of the processed signals is reference information having a numerical value of 1 and 0, or vice versa, in which case the product of the combination of the different parts (Xfront, Xback) of the signals is reference information having the numerical value of 1 or 0 and the product of the combination of the different parts (Yup, Ydown) of the signals is a numerical value between −1 and +1, and
when the product of the combination of the signal parts (Xfront, Xback) is a numerical value between −1 and +1, and the product of the combination of the different parts (Yup, Ydown) of the signals is reference information having the numerical value of 1 or 0, the directional angle of the directed directional pattern is calculated with the formula:
Angle=ABS(SIN⁻¹(PX)+90+(PY*180).

6. A method as claimed in claim 4, wherein
the generated third signal (Z) and the omni-directional signal (Wn) are combined with two separate summing means in such a manner that in the first summing means the third signal (Z) is added to the omni-directional signal (Wn), and in the second summing means the third signal (Z) is deducted from the omni-directional signal (Wn), whereby the third signal (Z) received by an dual-diaphragm acoustic transducer capable of providing a figure-of-eight directional pattern can be divided into two parts (Zup, Zdown).

7. A method as claimed in claim 6, wherein the method further comprising:
processing the signal strength of the combined signal parts (Zup, Zdown) in a signal processing block separately in accordance with predefined selection criteria,
combining the different parts of the processed signals (Zup, Zdown) to form numerical values (PZ, PZ) for the calculation of a directional angle, in which the product of the combination of the different parts (Zup, Zdown) of the processed signals is numerical information between −1 and +1,
calculating on the basis of the numerical values (PZ, PZ) a directional angle of the elevation direction of the directed directional pattern, which angle points in the elevation direction of the provider of the acoustic signals processed according to the predefined selection criteria, and
transmitting the acoustic signals according to the directional angle of the elevation direction of the directed directional pattern for signal transfer or reproduction.

8. A method as claimed in claims 4 or 7, wherein information on the directional angle of the directed directional pattern is also transmitted for signal transfer or reproduction.

9. A method as claimed in claims 4 or 7, wherein one of the predefined criteria is a frequency criterion.

10. A method as claimed in claims 4 or 7, wherein one of the predefined criteria is a criterion related to response time.

11. A system for receiving acoustic signals for reproduction, comprising:
two dual-diaphragm acoustic transducers arranged to receive acoustic signals and capable of providing a figure-of-eight directional pattern, which are directed on two-dimensional plane perpendicular to each other, while the directional patterns have directional pattern halves (XA, XB) and (YA, YB), respectively,
first combination means for generating from the acoustic signals received by the acoustic transducers a first signal (X), wherein (X=XA−XB), and a second signal (Y), wherein Y=(YA−YB), wherein the system also comprises
second combination means for generating an omni-directional signal (Wn) having an omni-directional pattern, wherein n {X,Y}, in which (Wn) is calculated by adding together the directional pattern halves (XA, XB) and/or (YA, YB) of one or two signals in such a manner that the two dual-diaphragm acoustic transducers provide simultaneously not only the first (X) and second (Y) signals, but also the omni-directional signal (Wn) having an omni-directional pattern, and with the combination of the three generated signals (X, Y, Wn), it is possible to provide a directed directional pattern pointing in the desired direction on two-dimensional plane.

12. A system for receiving acoustic signals for reproduction, comprising:
three dual-diaphragm acoustic transducers for receiving acoustic signals, which are capable of providing a figure-of-eight directional pattern and are directed in three-dimensional space perpendicular to each other, while the directional patterns have directional pattern halves (XA, XB), (YA, YB) and (ZA, ZB) respectively,
first combination means for generating from the acoustic signals received by the acoustic transducers a first signal (X), a second signal (Y), and a third signal (Z), wherein Z=(ZA−ZB), and
second combination means for generating an omni-directional signal (Wn) having an omni-directional pattern, wherein n {X,Y,Z}, in which (Wn) is calculated by adding together the directional pattern halves of the signals received by one, two, or three dual-diaphragm acoustic transducers in such a manner that the three dual-diaphragm acoustic transducers capable of providing a figure-of-eight directional pattern provide simultaneously not only the first (X), second (Y) and third (Z) signals, but also the omni-directional signal (Wn) having an omni-directional pattern, and with the combination of the four generated signals (X, Y, Z, Wn), it is possible to provide a directed directional pattern pointing in the desired direction on three-dimensional plane.

13. A system as claimed in claim 12, wherein
the second combination means are arranged to generate an omni-directional signal (WXYZ) having an omni-directional pattern, wherein (WXYZ=XA+XB+YA+YB+ZA+ZB), in such a manner that the three acoustic transducers capable of providing a figure-of-eight directional pattern provide simultaneously not only the first (X), second (Y), third (Z) signals, but also the signal (WXYZ) having an omni-directional pattern.

14. A system as claimed in claim 11, wherein the system further comprises
third summing means that are arranged to combine the generated first signal (X) and the omni-directional signal (Wn) with two separate summing means in such a manner that the first summing means (102) are arranged to add the first signal (X) to the omni-directional signal (Wn), and the second summing means (103) are arranged to deduct the first signal (X) from the omni-directional signal (Wn), whereby the first signal (X) received by an dual-diaphragm acoustic transducer capable of providing a figure-of-eight directional pattern can be divided into two parts (Xfront, Xback),
fourth summing means arranged to combine the generated second signal (Y) and the omni-directional signal (Wn) with two separate summing means in such a manner that the first summing means are arranged to add the second signal (Y) to the omni-directional signal (Wn), and the second summing means are arranged to deduct the second signal (Y) from the omni-directional signal (Wn), whereby the second signal (Y) received by an dual-diaphragm acoustic transducer capable of providing a figure-of-eight directional pattern can be divided into two parts (Yright, Yleft),
a signal processing block for processing the signal strength of the combined signal parts (Xfront, Xback) and (Yright, Yleft) separately in accordance with predefined selection criteria,
a combination part for combining the different parts (Xfront, Xback) and (Yright, Yleft) of the processed signals for calculating numerical values (PX, PY) for the computation of a directional angle,
a calculation unit for calculating on the basis of the numerical values (PX, PY) a directional angle of the directed directional pattern on 2D plane, which points in the direction of the provider of the acoustic signals processed according to the predefined selection criteria, and for transmitting the acoustic signals according to the directional angle of the elevation direction of the directed directional pattern for signal transfer or reproduction.

15. A system as claimed in claim 14, wherein
the combination part provides as a product of the combination of the signal-processed signal parts (Xfront, Xback) a numerical value between −1 and +1, and as a product of the combination of the different signal-processed signal parts (Yup, Ydown) reference information having the numerical value of 1 or 0, or vice versa, in which case the product of the combination of the different parts (Xfront, Xback) of the signals is reference information having the numerical value of 1 or 0, and the product of the combination of the different parts (Yup, Ydown) of the signals is a numerical value between −1 and +1, and
when the product of the combination of the different parts (Xfront, Xback) of the signals is a numerical value between −1 and +1, and the product of the combination of the different parts (Yup, Ydown) of the signals is reference information having the numerical value of 1 or 0, the directional angle of the directed directional pattern is calculated with the formula:
Angle=ABS(SIN−1(PX)+90+(PY*180).

16. A system as claimed in claim 14, wherein the system also comprises:
fifth summing means arranged to combine the generated third signal (Z) and the omni-directional signal (Wn) with two separate summing means in such a manner that the first summing means are arranged to add the third signal (Z) to the omni-directional signal (Wn) and the second summing means are arranged to deduct the third signal (Z) from the omni-directional signal (Wn), whereby the third signal (Z) received by an dual-diaphragm acoustic transducer capable of providing a figure-of-eight directional pattern can be divided into two parts (Zup, Zdown), and
the signal processing block is arranged to process the signal strength of the combined signal parts (Zup, Zdown) separately according to predefined selection criteria,
the combination part is arranged to combine the different parts (Zup, Zdown) of the processed signals to form numerical values (PZ, PZ) for the calculation of a directional angle, in which the product of the combination of the different parts (Zup, Zdown) of the processed signals is a numerical value between −1 and +1,
a calculation unit arranged to calculate on the basis of the numerical values (PZ, PZ) the directional angle of the elevation direction of the directed directional pattern that points in the elevation direction of the provider of the acoustic signals processed according to the predefined selection criteria, and to transmit the acoustic signals according to the directional angle of the directed directional pattern for signal transfer or reproduction.

17. A system as claimed in claim 14, wherein the system has a conference microphone that, on the basis of the received signals, points the directed directional pattern towards the provider of the acoustic signals.

18. An apparatus for receiving acoustic signals for reproduction, wherein the apparatus implements the method of claim 1.
